(19) United States
(12) Patent Application Publication
(10) Pub. No.: US 2018/0112774 A1
(43) Pub. Date: Apr. 26, 2018

(54) PARK CONTROL SYSTEM FOR A VEHICLE TRANSMISSION

(71) Applicant: GM GLOBAL TECHNOLOGY OPERATIONS LLC, DETROIT, MI (US)

(72) Inventors: Joseph R. Littlefield, Waterford, MI (US); Dumitru Puiu, Sterling Heights, MI (US)

(21) Appl. No.: 15/299,497

(22) Filed: Oct. 21, 2016

(51) Int. Cl. F16H 63/34

(52) U.S. Cl. CPC F16H 63/3433; F16H 63/3466

(57) ABSTRACT

A vehicle includes a park actuator motor that is external to a transmission housing in the vehicle, a default to park mechanism that is internal to the transmission housing, and a park inhibit solenoid that is internal to the transmission housing.

### FIELD

The present disclosure relates to a park control system for a vehicle transmission.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

A typical automatic transmission includes a hydraulic control system that is employed to provide cooling and lubrication to components within the transmission and to actuate a plurality of torque transmitting devices. These torque transmitting devices may be, for example, friction clutches and brakes arranged with gear sets or in a torque converter. The conventional hydraulic control system typically includes a main pump that provides a pressurized fluid, such as oil, to a plurality of valves and solenoids within a valve body. The main pump is driven by the engine of the motor vehicle. The valves and solenoids are operable to direct the pressurized hydraulic fluid through a hydraulic fluid circuit to various subsystems including lubrication subsystems, cooler subsystems, torque converter clutch control subsystems, and shift actuator subsystems that include actuators that engage the torque transmitting devices. The pressurized hydraulic fluid delivered to the shift actuators is used to engage or disengage the torque transmitting devices in order to obtain different gear ratios.

The transmission generally operates in a plurality of modes of operation including out-of-Park driving modes and a Park mode. The out-of-Park driving modes generally include the forward gear or speed ratios (i.e. a Drive mode), at least one reverse gear or speed ratio (i.e. a Reverse mode), and a Neutral mode. Selection of the various driving modes is typically accomplished by engaging a shift lever or other driver interface device that is connected by a shifting cable or other mechanical connection to the transmission.

Alternatively, the selection of a driving mode may be controlled by an electronic transmission range selection (ETRS) system, also known as a “shift by wire” system. In an ETRS system, selection of the driving modes is accomplished through electronic signals communicated between the driver interface device and the transmission. The ETRS system reduces mechanical components, increases instrument panel space, enhances styling options, and eliminates the possibility of shifting cable misalignment with transmission range selection levers. New propulsion system architectures may no longer rely upon clutches and, thus, may no longer incorporate a hydraulic control system.

These control systems must meet specific safety requirements for new transmission and vehicle designs during particular failure modes of operation. In the absence or reduced availability of hydraulic systems in these new propulsion system architectures, these safety related functions are typically met by mounting a system external to the housing of the transmission. A shaft may extend out of the transmission housing and is connected to this external system. This external system must provide several features including: defaulting to park in a complete power loss situation; maintaining an out-of-park configuration when desired despite a single element failure; and maintaining the motive ability to move between the out-of-park configuration and park configuration and vice-versa on command. Since this external component is required to provide all of the features, the external component typically includes electromechanical actuators with motors, sensors, controllers, etc. This external system is bulky, complex with several components, and is quite expensive.

### SUMMARY

In an exemplary aspect, a vehicle includes a park actuator motor that is external to a transmission housing in the vehicle, a default to park mechanism that is internal to the transmission housing, and a park inhibit solenoid that is internal to the transmission housing.

In another exemplary aspect, the default to park mechanism includes a helical spring on an actuator rod biasing an actuator bullet away from a fixed slider.

In another exemplary aspect, the park actuator motor is actuable to apply torque to a hold a detent plate in a park configuration against the helical spring.

In another exemplary aspect, the vehicle further includes a fixed slider mounted on a fixed solenoid mount and slidably receiving the actuator rod. The helical spring is captured between the fixed slider and the actuator bullet on the actuator rod.

In another exemplary aspect, the vehicle further includes a movable slider pivotally mounted on the detent plate and slidably receiving the actuator rod.

In another exemplary aspect, the vehicle further includes a slider stop on an end of the actuator rod opposite the actuator bullet.

In another exemplary aspect, the vehicle further includes a detent plate pivotally mounted on an actuator shaft a detent spring mounted to a park guide at a proximal end and including a detent roller at a distal end. The detent roller is biased into contact with a detent surface of the detent plate. A solenoid shaft of the park inhibit solenoid is selectively extendable into contact with the detent roller to capture the detent roller between the solenoid shaft and the detent surface at an out-of-park valley on the detent surface.

In another exemplary aspect, the detent plate further includes a solenoid shaft stop adjacent the out of park valley of the detent surface.

In another exemplary aspect, the default to park mechanism includes a torsion spring mounted on an actuator rod biasing a detent plate to rotate and bias an actuator bullet into a park configuration.

In another exemplary embodiment, the vehicle further includes an actuator shaft connected to the park actuator motor to selectively receive torque from the park actuator motor and the actuator shaft extends into the transmission housing, a detent plate mounted on the actuator shaft and including a detent surface with a zero load portion, a park valley and a ramp surface between the zero load portion and the park valley, and a detent spring fixedly mounted at a proximal end and including a detent roller at a distal end. The detent spring biasing the detent roller into contact with the detent surface.

In this manner, all desired features may be met using components internal to the transmission housing, even in the absence of hydraulic systems, thereby significantly reducing the size of the overall system, improving packaging, reducing weight, and providing improved diagnostic abilities and control. Further, this new architecture removes access to a controller area network by a component which is external to the transmission system, thereby improving security of the overall system. Additionally, moving the functionality internally to the transmission improves control, provides redundancy, and improves the ability to diagnose the system.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of an exemplary propulsion system in a vehicle;

FIG. 2 is a perspective view of an exemplary park control system in accordance with the present invention;

FIG. 3 is another perspective view of the exemplary park control system of FIG. 2;

FIG. 4 is a close up perspective view of a portion of the exemplary park control system of FIG. 2;

FIG. 5A is a side view of the exemplary park control system of FIG. 2 in an out of park configuration;

FIG. 5B is a side view of the exemplary park control system of FIG. 2 transitioning from an out of park configuration to a park configuration;

FIG. 5C is a side view of the exemplary park control system of FIG. 2 in a park configuration;

FIG. 6A is another side view of the exemplary park control system of FIG. 2 in a stuck solenoid configuration;

FIG. 6B is another side view of the exemplary park control system of FIG. 2 in a stuck solenoid remedy configuration;

FIG. 7 is a perspective view of another exemplary park control system in accordance with the invention in an out of park configuration; and

FIG. 8 is a perspective view of the exemplary park control system of FIG. 8 in a park configuration.

### DETAILED DESCRIPTION

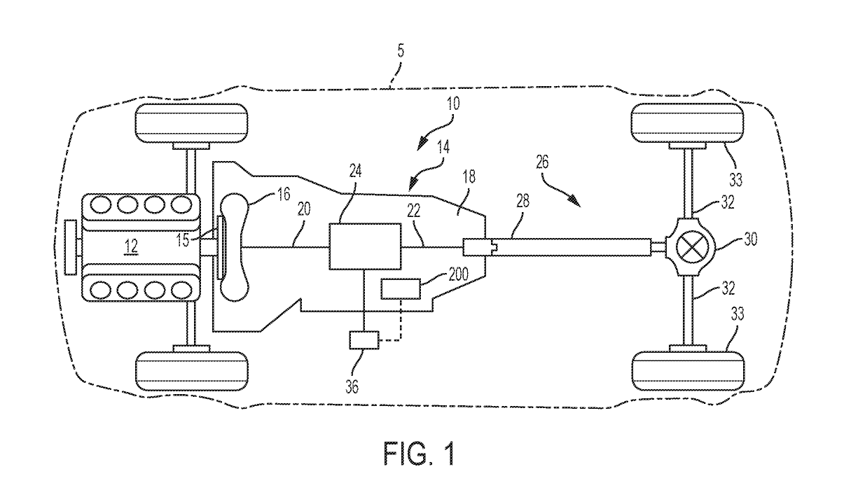

With reference to FIG. 1, a vehicle is illustrated and generally indicated by reference number 5. The vehicle 5 is illustrated as a passenger car, but it should be appreciated that the vehicle 5 may be any type of vehicle, such as a truck, van, sport-utility vehicle, etc. The vehicle 5 includes an exemplary propulsion system 10. It should be appreciated at the outset that while a rear-wheel drive propulsion system has been illustrated, the vehicle 5 may have a front-wheel drive propulsion system without departing from the scope of the present invention. The propulsion system 10 generally includes a prime mover 12 interconnected with a transmission 14.

The prime mover 12 may be a conventional internal combustion engine or an electric engine, hybrid engine, or any other type of prime mover, without departing from the scope of the present disclosure. The prime mover 12 may supply a driving torque to the transmission 14 through a flex plate 15 or other connecting device that is connected to a starting device 16. The starting device 16 may be a hydrodynamic device, such as a fluid coupling or torque converter, a wet dual clutch, or an electric motor. It should be appreciated that any starting device between the prime mover 12 and the transmission 14 may be employed including a dry launch clutch.

The transmission 14 has a typically cast, metal housing 18 which encloses and protects the various components of the transmission 14. The housing 18 may include a variety of apertures, passageways, shoulders and flanges which position and support these components. Generally speaking, the transmission 14 includes a transmission input shaft 20 and a transmission output shaft 22. The transmission input shaft 20 is functionally interconnected with the engine 12 via the starting device 16 and receives input torque or power from the engine 12. Accordingly, the transmission input shaft 20 may be a turbine shaft in the case where the starting device 16 is a hydrodynamic device, dual input shafts where the starting device 16 is dual clutch, or a drive shaft where the starting device 16 is an electric motor. The transmission output shaft 22 may be connected with a final drive unit 26 which includes, for example, a prop shaft 28, differential 30, and drive axles 32 connected to wheels 33.

The gear and clutch arrangement 24 includes a plurality of gear sets, a plurality of clutches and/or brakes, and a plurality of shafts. The plurality of gear sets may include individual intermeshing gears, such as planetary gear sets, that are connected to or selectively connectable to the plurality of shafts through the selective actuation of the plurality of clutches/brakes. The plurality of shafts may include layshafts or countershafts, sleeve and center shafts, reverse or idle shafts, or combinations thereof. The clutches/brakes, indicated schematically by reference number 34, are selectively engageable to initiate at least one of a plurality of gear or speed ratios by selectively coupling individual gears within the plurality of gear sets to the plurality of shafts. It should be appreciated that the specific arrangement and number of the gear sets, clutches/brakes 34, and shafts within the transmission 14 may vary without departing from the scope of the present disclosure.

The transmission 18 includes a transmission control module 36. The transmission control module 36 is preferably an electronic control device having a preprogrammed digital computer or processor, control logic or circuits, memory used to store data, and at least one I/O peripheral. The control logic includes or enables a plurality of logic routines for monitoring, manipulating, and generating data and control signals. In another example, the transmission control module 36 is an engine control module (ECM), or a hybrid control module, or any other type of controller.

FIG. 1 also shows a schematic representation of a park control system 200 positioned within the transmission housing 18 and in communication with the transmission control module 36.

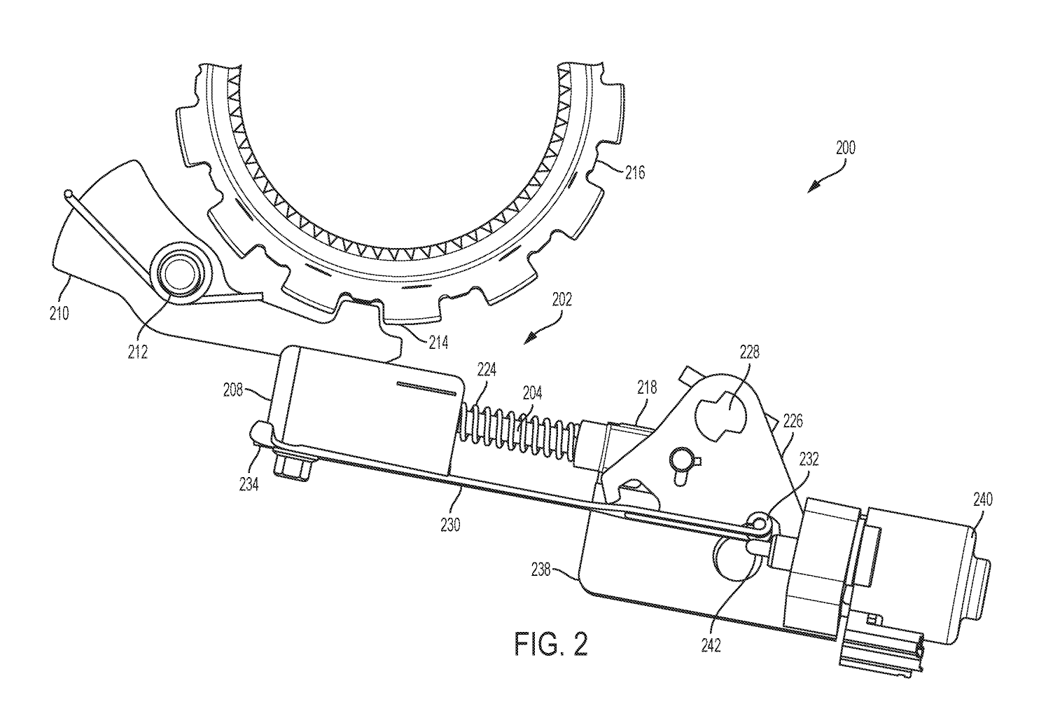

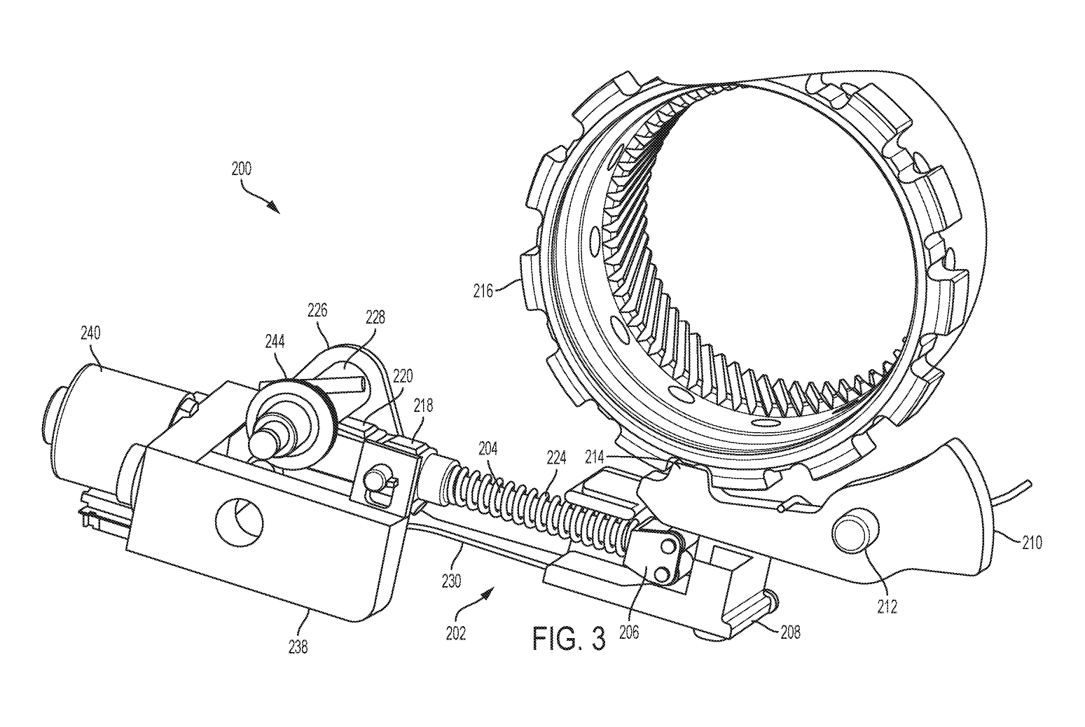

Referring now generally to FIGS. 2 through 6B, a first exemplary embodiment of a park control system 200 in accordance with the present invention is described. Starting with FIGS. 2 and 3, the components of the park control system 200 are introduced. The park control system 200 operates in communication with a park actuator 202. The park actuator 202 includes an actuator rod 204 with a park bullet 206 at one end which is captured within and guided by park guide 208. The park bullet 206 is in contact with a park pawl 210. The park bullet 206 moves along internal camming surfaces of the park guide 208 to cause the park pawl 210 to selectively rotate about a pawl pivot 212 and to engage a pawl tooth 214 into selective engagement with park gear 216.

Actuator rod 204 is received within a fixed slider 218 and a movable slider 220. The end of the actuator rod 204 opposite the park bullet 206 includes a slider stop 222 which limits the motion of the fixed slider 218 and movable slider 202 along the actuator rod 204. A rod spring 224 is also positioned on the actuator rod 204 between the park bullet 206 and the fixed slider 218 and biases the park bullet 206 and fixed slider 218 away from each other. The fixed slider 218 is fixed to a solenoid mount 238 and is, thereby, held stationary.

The movable slider 220 is rotatably mounted to a detent plate 226. The detent plate 226 is pivotally mounted to an actuator shaft 228. A detent spring 230 is mounted to the park guide 208 at a proximal end 234, so that it is fixed to a stationary position, and includes a detent roller 232 mounted on a distal end of the park guide 230. The detent spring 230 biases the detent roller 232 into rolling contact with detent surface 236 of the detent plate 226.

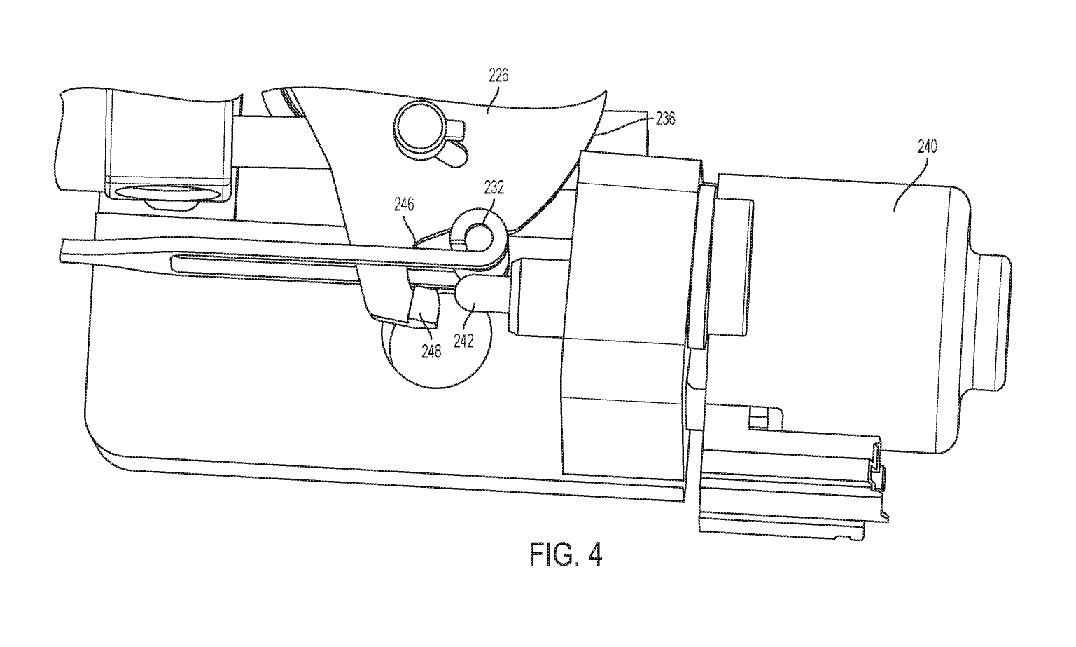

A solenoid 240 is mounted to the solenoid mount 238 and includes a solenoid shaft 242 that selectively extends from the solenoid 240. The solenoid shaft 242 is positioned such that it selectively contacts the detent roller 232 and holds the detent roller 232 in contact with the detent surface 236 of the detent plate 226 when the solenoid 240 is energized. Contact between the solenoid shaft 242 and the detent roller 232 is clearly illustrated in FIG. 4.

An actuator motor 244 is mounted on the actuator shaft 228. The actuator motor 244 selectively applies torque to the actuator shaft 228 to rotate the detent plate 226 in a desired direction. The actuator motor 244 may include an internal spring (not shown) which may bias rotation of the actuator shaft 228 in a predetermined direction.

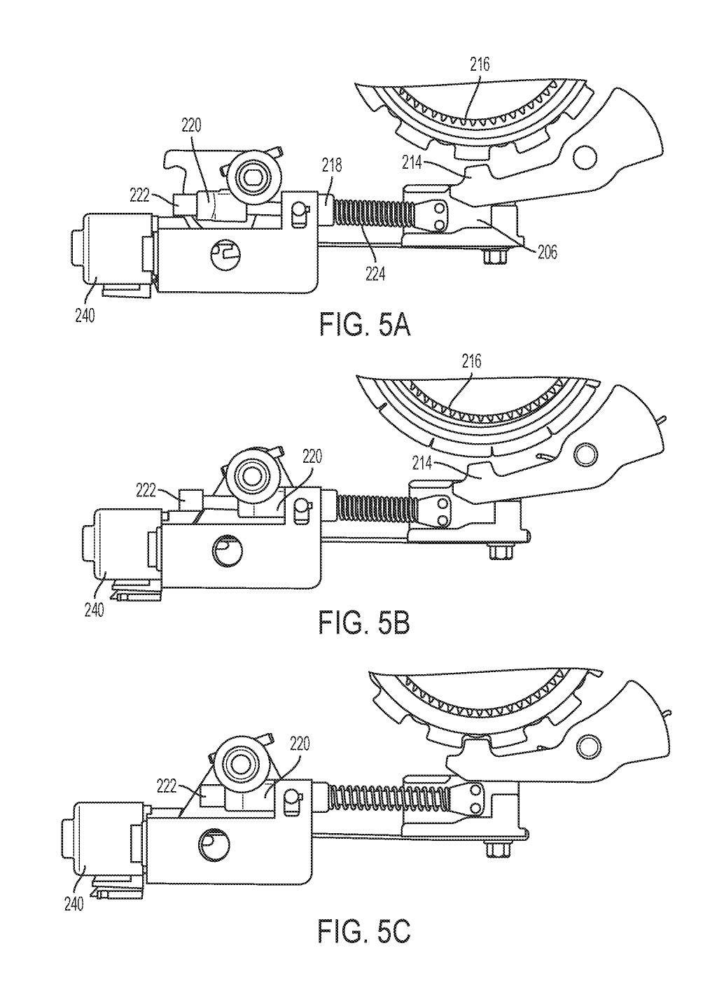

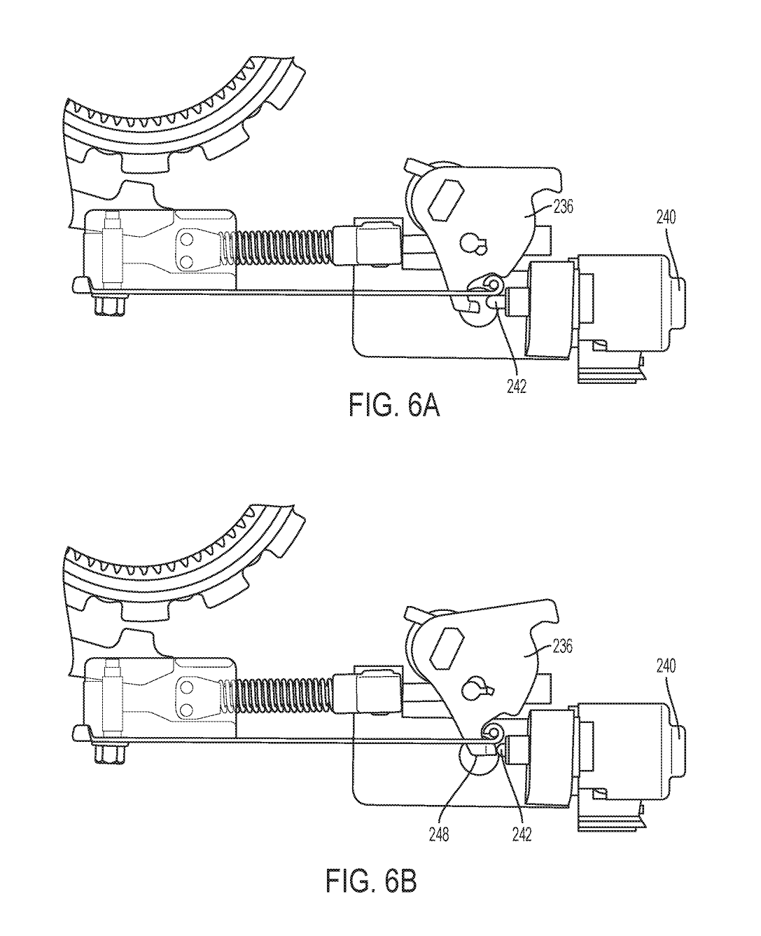

Operation of the park control system 200 is now described with reference generally to FIGS. 2-6B. FIGS. 5A and 6A illustrate the park control system 200 in an out of park configuration where the pawl tooth 214 does not engage with the park gear 216. As can be seen in FIG. 5A, the rod spring 224 is compressed between the park bullet 206 and the fixed slider 218. In order to maintain this out of park configuration, the actuator rod 204 must be held such that it resists the biasing force of the rod spring 224 which is trying to move the actuator rod 204 into a park configuration.

The park control system 200 includes two separate and independent, redundant, systems to hold the actuator rod 204 in the out of park position. The actuator motor 244 applies a torque to the actuator shaft 228 and, in turn, to the detent plate 226. The actuator motor 244 applies a torque in a clockwise direction in FIG. 5A to the detent plate 226. The movable slider 220, being pivotally mounted to the detent plate 226, is pushed by the detent plate 226 against the slider stop 222 on the actuator rod 204. The torque being applied by the actuator motor 244 in this configuration is sufficient to resist the biasing force of the rod spring 224 and holds the rod spring 224 in a compressed state.

In addition to the torque applied by the actuator motor 244, the solenoid 240 is energized such that the solenoid shaft 242 extends into contact with the detent roller 232 (see FIGS. 2, 4 and 6A). The solenoid shaft 242 holds the detent roller 232 within an out of park valley 246 on the detent surface 236 of the detent plate 226. Contact between the detent roller 232 and the detent surface 236 in the out of park valley 246 prevents the detent plate 226 from rotating in a clockwise direction in FIGS. 4 and 6A in response to the biasing force of the rod spring 224. In this manner, energizing the solenoid 240 enables the holding of the out of park configuration. The combination of the actuator motor 244 being energized and the solenoid 244 being energized provides separate, independent, and redundant systems to maintain an out of park configuration. Failure by either the actuator motor 244 or the solenoid 244 will not result in the rod spring 224 moving the actuator rod 204 into a park position.

When commanded to transition from the out of park configuration to the park configuration, the solenoid 240 and actuator motor 244 may both be de-energized. The solenoid 240 is de-energized such that the solenoid shaft 242 is withdrawn and moved away from contact with the detent roller 232. The rod spring 224 de-compresses, pushes the park bullet 206 away from the fixed slider 218, which causes the actuator rod 204 to move the slider stop 222 to the right in FIGS. 5A-5C which permits the detent plate 226 to rotate in a counter-clockwise direction and the detent roller 232 is released (by the retraction of the solenoid shaft 242) to roll out of the out of park valley 246 of the detent surface 236 of the detent plate 226. In this manner, the park configuration illustrated in FIG. 5C is achieved.

The rod spring 224 being biased to push the park bullet 206 away from the fixed slider 218 provides a default to park function such that failure of any system or loss of power results in entry into the park configuration. Additionally, the rod spring 224 may provide a ratcheting capability in those instances where the park gear 216 may be rotating at a speed above a predetermined speed such that immediate engagement of the pawl tooth 214 with the park gear 216 is not desired. Only when the vehicle speed (and thus the rotation speed of the park gear 216) drops below a predetermined amount will the pawl tooth 214 engage with the park gear 216. Prior to that speed being achieved, the pawl tooth 214 “ratchets” along the park gear 216 and the flexibility of the park bullet 206 to move to accommodate that ratcheting is provided by the rod spring 224.

Optionally, the actuator motor 244 may provide torque to the actuator shaft 242 to further encourage the rotation of the detent plate 226 toward the park configuration.

In an instance where the solenoid shaft 242 gets stuck in the extended position, a solenoid shaft stop 248 may be provided on the detent plate 226 which pushes the solenoid shaft 242 into the retracted position when the actuator motor 244 rotates the detent plate 226 in a counter-clockwise direction as illustrated in FIG. 6B.

Transitioning from the park configuration to the out of park configuration follows the reverse process as that described above. The actuator motor 244 applies a torque to the actuator shaft 228 which causes the detent plate 226 to rotate in a clockwise direction (in FIGS. 5A-5C) against the biasing force of the rod spring 224 and which thereby compresses the rod spring 224 between the fixed slider 218 and the park bullet 206. Once the park configuration is achieved by the actuator motor 244, the solenoid 240 may then be energized to extend the solenoid shaft 242 into contact with the detent roller 232 to thereby lock the detent plate 226 in the out of park configuration.

In this manner, the park control system satisfies multiple requirements. The rod spring 224 provides a default to park function in the instance where power may be lost and/or multiple components fail. Further, the separate, independent, and redundant solenoid 240 and actuator motor 244 ensure that single element failure does not result in an undesirable entry into a park configuration. Lastly, the actuator motor 244 provides the ability to actively determine and select between the park and out of park configurations as commanded and/or desired.

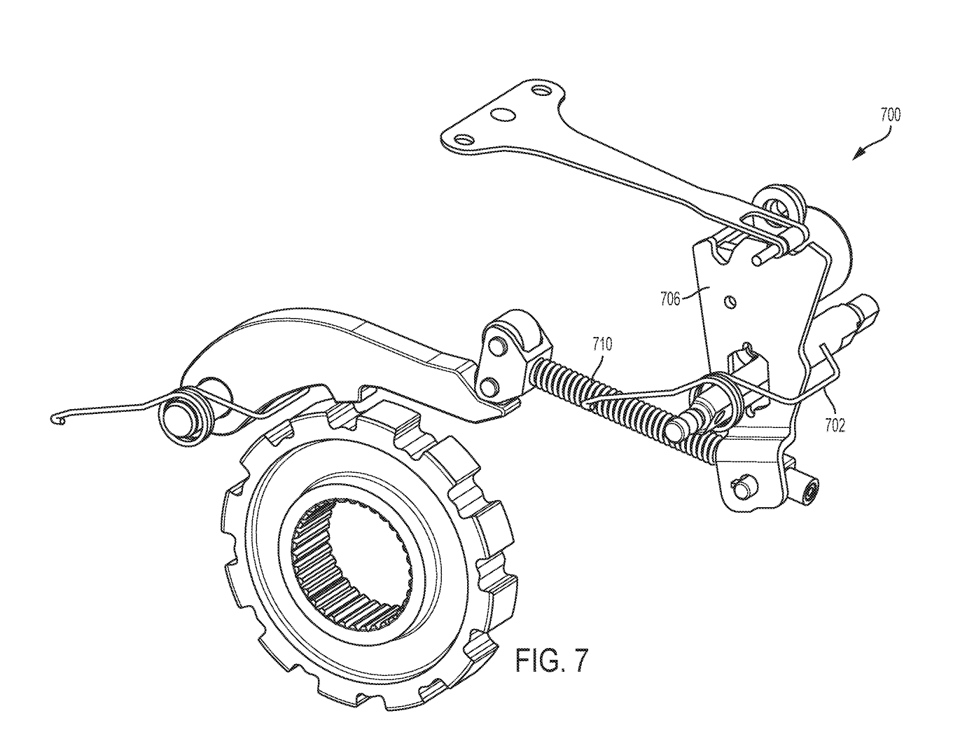

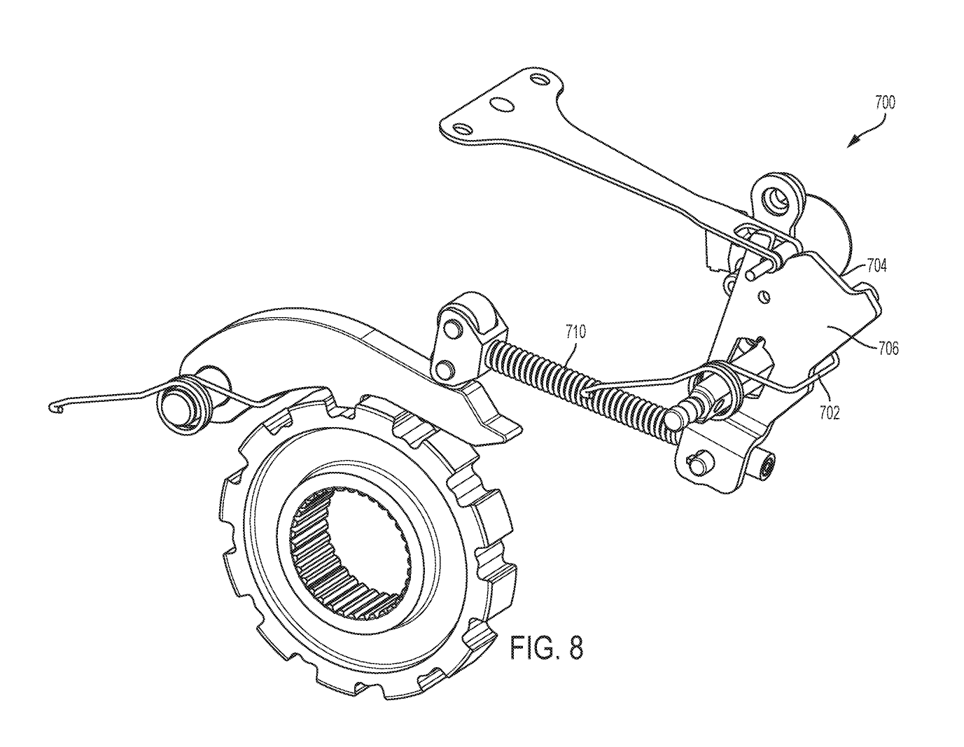

FIGS. 7 and 8 provide perspective views of another exemplary park control system 700 in accordance with the present invention. For ease of understanding, components which are not required for the understanding of the park control system 700 are not illustrated by FIGS. 7 and 8. The park control system 700 is similar to the park control system 200 described above with the following differences: there is no fixed slider 218, a torsion spring 802 is provided to the park control system 700, and the detent surface 704 of the detent plate 706 includes features specific to this park control system 700. Although for purposes of clarity components may not be illustrated by FIGS. 7 and 8, other components described above with respect to park control system 200 are shared by the park control system 700. The differences are further described below.

Torsion spring 702 is provided to bias rotation of the detent plate 706 toward the park configuration. In contrast to the park control system 200, a default to park function is provided by the torsion spring 702 in the park control system 700. In this manner, the strength of the rod spring 710 may be reduced in comparison to the rod spring 224 of the park control system 200. Since the strength of the rod spring 710 is reduced the power of the actuator motor (not shown) may also be reduced, which results in the ability to reduce the size of the actuator motor, and the amount of power consumed by the actuator motor when holding the out of park configuration. The rod spring 710 is not compressed when held in the out of park configuration and, thus, the actuator motor does not need to resist the rod spring 710 when holding the out of park configuration. Rather, the actuator motor only needs to resist the bias of the torsion spring 702.

Additionally, in the out of park configuration illustrated in FIG. 7, the detent roller 714 on a distal end of the detent spring 716 contacts a zero load portion 718 of the detent surface 704. The zero load portion 718 maintains a constant radial distance from the actuator shaft 720 about which the detent plate 706 pivots. In this configuration, the detent spring 716 does not apply any torque to the detent plate 706. Thus, the detent roller 714 does not apply any force or torque to the detent plate 706 that would need to be overcome to hold the out of park configuration by the torsion spring 702. Therefore, the out of park configuration is a low load configuration which requires very little power to hold the out of park configuration.

In contrast, in the park configuration illustrated in FIG. 8, the detent roller 714 is received in a park valley 722 on the detent surface 704 of the detent plate 706. The park valley 722 includes a ramp surface 724 on the detent surface 704 between the park valley 722 and the zero load portion 718 of the detent surface 704. In this manner, since a proximal end 726 of the detent spring 716 is mounted to a fixed surface (see, for example, FIG. 2) as the detent plate 706 rotates toward the park configuration, the detent roller 714 rolls down the ramp surface 724 and applies a force to the ramp surface 724 which converts to a torque on the detent plate 706 which further encourages the detent plate 706 toward the park configuration and assists the torsion spring 702.

Further, the strength of the torsion spring 702 may be optimized to provide a desired latency in the amount of time which may elapse during a transition from an out of park configuration into the park configuration. While the torsion spring 702 provides a default to park configuration in the instance of a complete power loss or failure of other components, there is a small amount of friction inherent in the system which resists the transition between the configurations. This is a desirable feature in a situation where a power loss is only momentary. The latency provides a delay before entry into the park configuration during a momentary power loss and which will enable the prevention of entry into the park configuration when power is restored and an out of park configuration may desirably be maintained.

Optionally, the torsion spring 702 may be combined with and/or substituted with another torsion spring (not illustrated) as may be incorporated into, for example, the actuator motor. Typically, an actuator motor may include a torsion spring (not illustrated) to remove lash from the system and/or to provide a “return to home position” function for the motor. In this instance, the torsion spring 702 function may be combined and/or substituted with or by a torsion spring internal to the actuator motor.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle comprising:
a park actuator motor that is external to a transmission housing in the vehicle;
a default to park mechanism that is internal to the transmission housing; and
a park inhibit solenoid that is internal to the transmission housing.

2. The vehicle of claim 1, wherein the default to park mechanism includes a helical spring on an actuator rod biasing an actuator bullet away from a fixed slider.

3. The vehicle of claim 2, wherein the park actuator motor is actuable to apply torque to a hold a detent plate in a park configuration against the helical spring.

4. The vehicle of claim 3, further comprising a fixed slider mounted on a fixed solenoid mount and slidably receiving the actuator rod, wherein the helical spring is captured between the fixed slider and the actuator bullet on the actuator rod.

5. The vehicle of claim 3, further comprising a movable slider pivotally mounted on the detent plate and slidably receiving the actuator rod.

6. The vehicle of claim 5, further comprising a slider stop on an end of the actuator rod opposite the actuator bullet.

7. The vehicle of claim 1, further comprising:
a detent plate pivotally mounted on an actuator shaft;
a detent spring mounted to a park guide at a proximal end and including a detent roller at a distal end, wherein the detent roller is biased into contact with a detent surface of the detent plate, and wherein a solenoid shaft of the park inhibit solenoid is selectively extendable into contact with the detent roller to capture the detent roller between the solenoid shaft and the detent surface at an out-of-park valley on the detent surface.

8. The vehicle of claim 7, wherein the detent plate further includes a solenoid shaft stop adjacent the out of park valley of the detent surface.

9. The vehicle of claim 1, wherein the default to park mechanism includes a torsion spring mounted on an actuator rod biasing a detent plate to rotate and bias an actuator bullet into a park configuration.

10. The vehicle of claim 1, further comprising:
an actuator shaft connected to the park actuator motor to selectively receive torque from the park actuator motor and wherein the actuator shaft extends into the transmission housing;
a detent plate mounted on the actuator shaft and including a detent surface with a zero load portion, a park valley and a ramp surface between the zero load portion and the park valley; and
a detent spring fixedly mounted at a proximal end and including a detent roller at a distal end, the detent spring biasing the detent roller into contact with the detent surface.

11. A transmission for a vehicle comprising:
a park actuator motor that is external to a transmission housing;
a default to park mechanism that is internal to the transmission housing; and
a park inhibit solenoid that is internal to the transmission housing.

12. The transmission of claim 1, wherein the default to park mechanism includes a helical spring on an actuator rod biasing an actuator bullet away from a fixed slider.

13. The transmission of claim 12, wherein the park actuator motor is actuable to apply torque to a hold a detent plate in a park configuration against the helical spring.

14. The transmission of claim 13, further comprising a fixed slider mounted on a fixed solenoid mount and slidably receiving the actuator rod, wherein the helical spring is captured between the fixed slider and the actuator bullet on the actuator rod.

15. The transmission of claim 13, further comprising a movable slider pivotally mounted on the detent plate and slidably receiving the actuator rod.

16. The transmission of claim 15, further comprising a slider stop on an end of the actuator rod opposite the actuator bullet.

17. The transmission of claim 11, further comprising:
a detent plate pivotally mounted on an actuator shaft;
a detent spring mounted to a park guide at a proximal end and including a detent roller at a distal end, wherein the detent roller is biased into contact with a detent surface of the detent plate, and wherein a solenoid shaft of the park inhibit solenoid is selectively extendable into contact with the detent roller to capture the detent roller between the solenoid shaft and the detent surface at an out-of-park valley on the detent surface.

18. The transmission of claim 17, wherein the detent plate further includes a solenoid shaft stop adjacent the out of park valley of the detent surface.

19. The transmission of claim 11, wherein the default to park mechanism includes a torsion spring mounted on an actuator rod biasing a detent plate to rotate and bias an actuator bullet into a park configuration.

20. The transmission of claim 11, further comprising:
an actuator shaft connected to the park actuator motor to selectively receive torque from the park actuator motor and wherein the actuator shaft extends into the transmission housing;
a detent plate mounted on the actuator shaft and including a detent surface with a zero load portion, a park valley and a ramp surface between the zero load portion and the park valley; and
a detent spring fixedly mounted at a proximal end and including a detent roller at a distal end, the detent spring biasing the detent roller into contact with the detent surface.
